(19) United States
(12) Patent Application Publication
(10) Pub. No.: US 2008/0256562 A1
(43) Pub. Date: Oct. 16, 2008

(54) System and Method for Accessing Files in a Physical Data Storage

(76) Inventors: Ralph Wenkel, Muhltal (DE); Gerald Ristow, Griesheim (DE)

Correspondence Address: MEYERTONS, HOOD, KIVLIN, KOWERT & GOETZEL, P.C., P.O. BOX 398, AUSTIN, TX, 78767-0398, US

(21) Appl. No.: 12/040,280

(22) Filed: Feb. 29, 2008

(30) Foreign Application Priority Data
Apr. 11, 2007 (EP) 07 007 391.1

(51) Int. Cl. G06F 9/46

(52) U.S. Cl. 719/328

(57) ABSTRACT

Accessing files in a physical data storage. The system may include an application programming interface (API) layer, the API layer including an API which extends the class Java.io.file to include methods for file access requests. The system may further comprise at least one internal layer, the internal layer configured to transform a file access request into a database call. Finally, the system may include a storage layer with a database, the database being configured to access the physical storage in response to the database call.

### PRIORITY CLAIM

This application claims benefit of priority of European application no. 07 007 391.1 titled “System and Method for Accessing Files in a Physical Data Storage”, filed Apr. 11, 2007, and whose inventors are Ralph Wenkel and Dr. Gerald Ristow.

### INCORPORATION BY REFERENCE

European application no. 07 007 391.1 titled “System and Method for Accessing Files in a Physical Data Storage”, filed Apr. 11, 2007, and whose inventors are Ralph Wenkel and Dr. Gerald Ristow, is hereby incorporated by reference in its entirety as though fully and completely set forth herein.

### TECHNICAL FIELD

The present invention relates to a method for accessing files in a physical data storage of a database.

### DESCRIPTION OF THE RELATED ART

Files of a database are usually stored in a physical data storage, such as a RAID system, wherein the files are arranged with a certain file-folder structure. If a search for a desired file is to be performed, each folder and file contained in the physical storage needs to be opened and examined. This is a standard procedure performed by an operating system.

An application running on a client, which needs access to a file, must provide suitable mechanisms to initiate such a procedure. In the prior art, files of a XML database can be stored and retrieved via the well-known programming language Java using the Workspace Versioning and Configuration Management Application Programming Interface (WVCM API). A description of the WVCM API can for example be found at http://www.webdav.org/deltav/wvcm. Internally, the WVCM API uses the WebDAV protocol, which is an extension of the HTTP protocol.

However, the level of abstraction of the WVCM API is rather low and the effort for simple file storage, reading and finding is very high. In particular, the somewhat complicated concepts of the WebDAV protocol and the WVCM API must be known to a developer. Further, searching files and content of files in the database are only possible with a recursive walk in the file-folder structure and reading of every folder and file. In other words, to find specific files, every folder and file content has to be sent over a communication line to the client to be locally analyzed by logic implemented on the client side. This approach is slow and inefficient, since it requires substantial bandwidth between the client and the database server before a requested file is obtained.

Accordingly, improvements in searching databases are desired.

### SUMMARY OF THE INVENTION

Various embodiments are presented of a system and method for accessing files in a physical data storage of a database. In some embodiments, the system may include a memory medium which stores program instructions that are executable to implement various layers. For example, the system may include an application programming interface (API) layer. The API layer may include an API which extends the class Java.io.file to include at least one method for file access requests. The system may further include at least one internal layer, where the internal layer may transform a file access request into a database call. Finally, the system may include a storage layer with a database, where the database may be adapted to access the physical storage in response to the database call.

One advantage of various ones of the embodiments described herein is the programming efficiency gained for a developer of database applications by extending the class Jave.io.file with methods for file access requests. The Java.io.file is well-known by all experienced Java developers. It provides a simple and efficient interface for locating, reading and finding files. There is only a small effort to learn a new interface that is based on Java.io.file for file access.

In one embodiment, the API extending the class Java.io.file may include methods for finding a file, retrieving a file, searching the content of a file and obtaining a version of a file. The methods of the extension preferably do not directly access the file system of the database but rather the internal layer. However, depending on the specific implementation there may be more or only a part of the mentioned methods in the extending API.

In one embodiment, the at least one internal layer may be adapted to transform the file access request into a XQuery call. The API extending the class Java.io.file may include a method for initiating the execution of a XQuery call by the internal layer. XQuery is a highly efficient language for querying XML databases using, for example, the indices typically provided in such a database.

In one embodiment, the internal layer can transform the file access request into a call according to the WebDAV extensions to the HTTP protocol. Using the internal layer for such a transformation may effectively shield the details of the WebDAV protocol from the client, who may only be concerned with the extended Java based API. The WebDAV protocol may extend the functionality of HTTP to facilitate distributed authoring by providing a network protocol for creating interoperable, collaborative applications.

In one embodiment, both the internal layer and the storage layer may be provided on a data base server. As a result, the client side logic can be reduced and only necessary content may be sent over the communication line from the database to the client.

According to another aspect, embodiments relate to a method for accessing files in a physical data storage using a system of any of the embodiments described above. Alternatively, a memory medium storing program instruction executable to perform the method may be implemented.

### SHORT DESCRIPTION OF THE DRAWINGS

In the following detailed description presently preferred embodiments of the invention are further described with reference to the following figures:

FIG. 1: A schematic representation of the various layers of the system in an exemplary embodiment;

FIG. 2: An example of the extension of the class Java.io.file in an exemplary embodiment;

FIG. 3: A schematic representation of the process for storing a file in a database with an embodiment of the system; and

FIG. 4: A schematic representation of the process for retrieving a file in a database with an embodiment of the system.

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

Various embodiments are presented of a system and method for accessing files in a physical data storage of a database. In the following, various embodiments are described with reference to accessing files of a XML database. However, it is to be understood that the invention is not restricted to accessing XML files of such a database. On the contrary, the concepts of the present invention can be applied to accessing any type of files of any physical storage of a database.

One important example is the case of a registry/repository of a service oriented (software) architecture SOA. In an SOA, various processing objects may be made available to a user in the network as independent services that can be accessed in a standardized way. The objects of the SOA interoperate based on formal definitions which may be independent from the underlying hardware and software platform and programming language.

Managing an SOA is typically a complex and difficult task. Maintaining an overview of the whole landscape of processing objects such as web services, some of which may dynamically change over time, may be important in order to ensure that an application using the various processing objects properly operates. Applicant of the present invention has therefore developed a centralized registry/repository available under the trade name CentraSite™. CentraSite™ is effectively an XML database, which may include, among others, descriptions of the processing objects, e.g., the web services of the SOA. A web service can be described by a Web Services Description Language (WSDL) file. The WSDL file typically includes information about the function, the data, the data type, and/or the exchange protocols of the respective web service. A client intending to send a request to a certain web service can obtain the WSDL file, e.g., from CentraSite, to find out how to access the web service. An effective access to the WSDL files stored in the database may therefore be important both for the design time and the runtime of the SOA.

Another example of a database, which could be efficiently accessed according to embodiments described herein, can be provided by the Tamino XML server of applicant, which is a general purpose XML server for data management using Internet technologies.

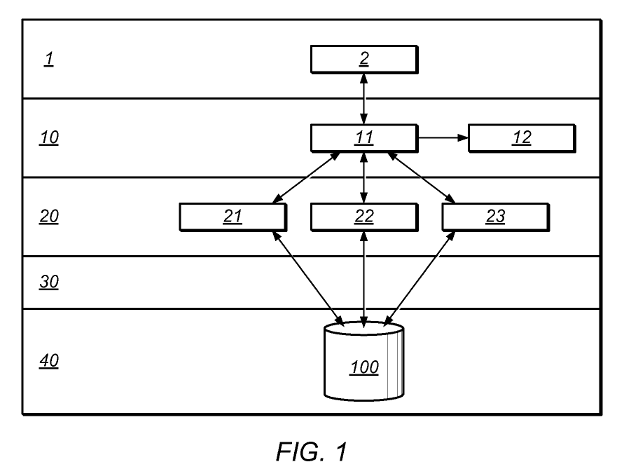

### FIG. 1

FIG. 1 presents an overview of the various layers of the system according to an embodiment. As can be seen, there may be an application layer 1 possibly comprising a client 2. The client may be, for example, a developer of the SOA needing access to some WSDL files of the database. In one embodiment, the client may be an application which may dynamically select a certain web service during runtime and also may need to access the WSDL file in order to find out how to address the web service.

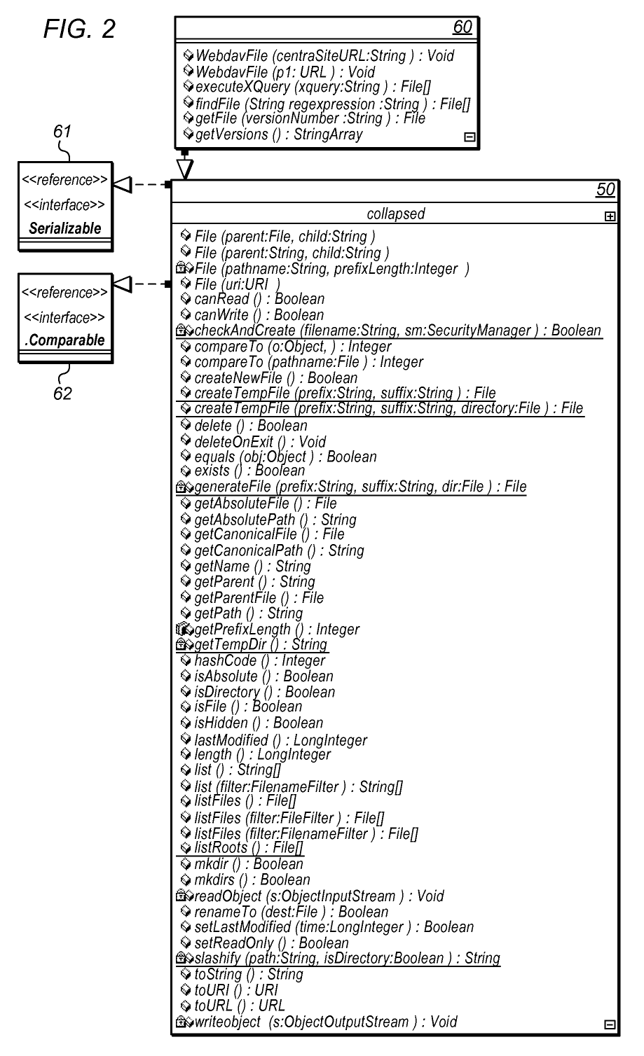

For issuing the file access request, the client 2 may use API 11 of a further layer, the so-called API layer 10. The API 11 may extend the Java.io.file 12 by methods for accessing files as described further below with reference to FIG. 2. In one embodiment, the extension is called “WebdavFile”. Depending on the method called by the client 2, the next layer of the system of FIG. 1, the internal layer 20, may transform the call into a suitable database request. To this end, the internal layer 20 may generate, in one embodiment, a database request in accordance with the WebDAV protocol (e.g., the WebDAV extensions to the HTTP protocol), e.g. by using the Workspace Versioning and Configuration Management API (WVCM API) 23.

Accordingly, rather than having directly to access the WVCM API, one embodiment may use a Java.io.file based view of the files and folders stored in database. This may lead to minimal effort for a developer to get started because all Java programmers are typically familiar with the Java.io.file class.

In another embodiment also shown in FIG. 1, the method call of the API 11 may be transformed by a query API 21 into an XQuery call. As will be apparent from the detailed description below, the transformation into an XQuery call may allow for efficiently searching and accessing the content of the database. Whereas the file accesses in the prior art do not provide benefits from a database based storage of the files, this embodiment may allow for an easy way to locate files with XQuery, where the benefits of an XML database as well as the knowledge of how the files are stored may be applied.

In addition to the WVCM API 23 and the query API 21, there could be more transformation units in the internal layer 20, as schematically indicated by the unit 22 in FIG. 1. Further, there could be more (internal) layers below the internal layer 20 additionally processing the file request. In fact, the boundary between the various layers 20, 30 and 40 is not fixed so that the number of layers may vary from implementation to implementation.

### FIG. 2

FIG. 2 schematically presents the extension of the Java.io.file in accordance with an embodiment. As can be seen, the Java.io.file class 50 may include a number of methods concerning the processing of files. The extension 60 of the Java.io.file 50 may provide additional methods for creating and managing files in a database such as CentraSite (for example, the method “WebDAVFile (centraSiteURL: String) in FIG. 2).

In the embodiment of FIG. 2, the extension 60 may further include a method for specifically initiating a XQuery call (e.g., the method “executeXQuery(xquery: string) in FIG. 2) and methods for finding and getting files from the database. Finally, there is a method for obtaining the version of a certain file.

In addition, FIG. 2 shows two further, optional interfaces 61 and 62 which may be implemented. The interface 61, called “serializable”, may serve for serialization and transmission of a file and the interface 62, “comparable”, may serve for comparisons.

An interface based on Java.io.file and with the possibility to use XQuery on a XML database may be a better and more efficient way to find and read files. The level of abstraction may be much higher compared to the WVCM API. For example, it can be used without understanding the WebDAV protocol. There is only a small effort to understand the new interface because it is based on the well known Java.io.file class. Preselection without client interaction for name, folder, properties, user, date/time, content and so on are possible. Additionally, methods can hide the structure of stored files and QXuery calls, making them invisible for the user. If the database requires authentication, further methods could be added to the extension 60, possibly with username and password as parameters.

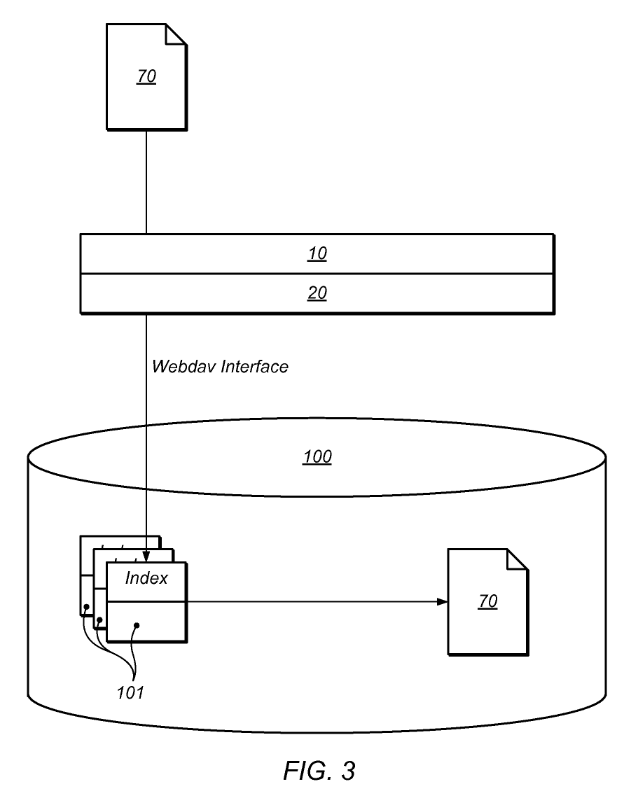

### FIG. 3

FIG. 3 illustrates a specific file access with the described system, namely the storing of a new file in the XML database. Using the API layer 10 and its extension of the Java.io.file 11 (not shown in FIG. 3), the file may be handed down to the internal layer 20 and the WVCM API 23 (also not explicitly shown on FIG. 3), may provide the necessary WebDAV interface to store the XML file 70 in the database 100.

Finally, the XML file 70 may be stored in an XML database 100. Automatically generated indices 101 may help to reduce the effort on finding files, locating them and determining the content of files. During file storage, different indexes 101 may be written and the file 70 may be stored in an efficient way. This decreases the required effort to locate and read files.

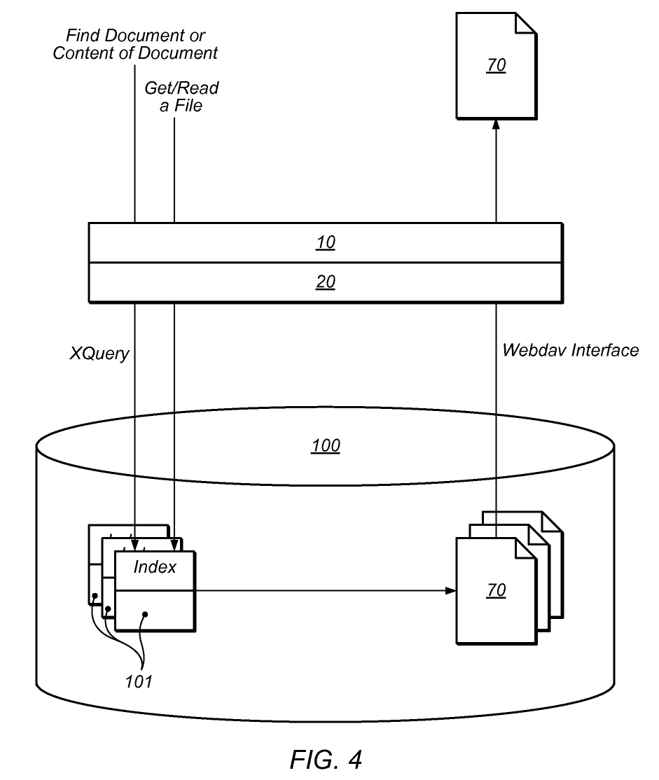

### FIG. 4

FIG. 4 illustrates the reverse type of file access, e.g., the retrieval of a file 70 from the XML database 100 using XQuery. XQuery is a standardized way to access XML data. By placing the XML files 70 in a XML database and using indices 101 and optimized XQuery calls, the search results may be available much faster. This applies to searching for file names, for file attributes, for file properties, and/or for content in the files. In particular, the search may be server side based without client logic or interaction. No transfer of subresults e.g. folder content to the client 2 may be necessary.

The XML files stored as WebDAV resources can be mapped to database collections in a flat structure, for example a collection “documents”. In that case, all files may be directly located in that collection and not in a recursive folder structure. XQuery can then be used to search in that collection. For example the following XQuery:

for $i in collection (“documents”)
return tdf:getProperties ($i)

may return all properties for all stored XML files in the collection “documents”. Such properties may include:
Name and Location of the file
owner
Date/Time information: modification date, last modified date, creation date
Length
Content type
Version number

Other methods for more properties are available.

A filter can dramatically reduce the amount of data. Using the name, the file can directly be located and returned. Searching for filenames, folders, owner, creation- and modification-date may be easily possible. With only one XQuery call, it is possible to find one or more files independent from which folder they are located below a given path. A corresponding XQuery example reads:

for $i in tdf:resource(“/ino:dav/ino:dav/projects/WSDL/”, “infinity”)
return tdf:getProperties($i)

which may return all files from the location/path “/ino:dav/ino:dav/projects/WSDL/” and its subfolders. If the Depth “1” is used instead of “infinity” all files from that folder without subfolders may be returned. “0” may return information about the appropriate folder only.

XQuery can also be used to restrict the result set from the database search to files with specific patterns in their full names (which includes the path). Consider the following XQuery:

declare namespace D=“DAV:”
for $i in collection(“documents”)
let $p := tdf:getProperties($i)
where tf:containsText($p/D:href,
“/CentraSite/CentraSite/ino:dav/ino:dav/projects/BusinessProcessMetaData/*.xml”)
return $i

The “for” statement in the second line chooses all documents from the collection “documents”. The next line maps the WebDAV properties of the result set to the variable $p. In the where statement in line 4, the result set may be restricted to documents in the folder “/CentraSite/CentraSite/ino:dav/ino:dav/projects/BusinessProcessMetaData/” which have a file extension of xml. The statement:

where tf:containsText($p/D:href, “*BusinessProcessMetaData/*”)

may retrieve all documents with a string of “BusinessProcessMetaData” in their full name. If documents whose full names are ending in gif or jpg are sought for, the statement may read:

where tf:containsText($p/D:href, “*.gif”) or tf:containsText($p/D:href, “*.jpg”)

It is also possible to use regular expressions in the search string if the underlying XQuery implementation supports this.

Using XQuery, a given file folder structure on a physical storage can be mapped to different database collections. For example, a root directory of the storage can be mapped to a specific collection so that an XQuery search looks only into one specific collection where all relevant files are stored without hierarchy. In the example above, files may be selected by looking at their Webdav properties via the build in function “tdf.getProperties( )”. The selection may be performed on the database side making the search very efficient. The returned list can provide the content or the properties of the selected files.

The invention is also applicable if non-XML files are stored in the XML database. In this case, searching over file properties like date, time or storage location may still be as fast as for XML data. Searching the content may not be possible by default, but can be achieved by connecting an automatic indexer which supports a variety of document and image formats like DOC, PDF, GIF, JPEG.

To illustrate the technical benefits of various embodiments, very few statements of a program are shown below, which may be necessary for retrieving all WSDL files in a directory “MyFirstProject” including its subdirectories and also for finding all files and folders with the string “*page*” in this directory and its subdirectories:

try {
WebdavFile wedavFile = new
WebdavFile(“localhost:53305/CentraSite/CentraSite/ino:dav/ino:dav/documents/Application
Composer”, “testuser”, “testpassword”);

Filefiles[ ] = wedavFile.findFile(“*MyFirstProject/*.wsdl”); // 1.
Filefiles[ ] = wedavFile.fmdFile(“*MyFirstProject/*page*”); // 2.
// easy to check it is a file or folder
if(file.isFile( )) {
...

} catch(WebdavFileException wfe) { }

If instead the known WVCM API is directly used to perform these file related operations, more than a hundred lines of Java code would be necessary to accomplish the same task. Thus, embodiments described herein allow for more efficient method for accessing files in a database.

Although the embodiments above have been described in considerable detail, numerous variations and modifications will become apparent to those skilled in the art once the above disclosure is fully appreciated. It is intended that the following claims be interpreted to embrace all such variations and modifications.

1. A computer-accessible memory medium storing program instructions for accessing files in a physical data storage, wherein the program instructions are executable to implement:
an application programming interface (API) layer, wherein the API layer comprises an API extending the class Java.io.file to include at least one method for file access requests;
at least one internal layer, wherein the internal layer is configured to transform a file access request into a database call; and
a storage layer comprising a database, wherein the database is configured to access the physical storage in response to the database call.

2. The computer-accessible memory medium of claim 1, wherein the API extending the class Java.io.file comprises methods for finding a file, retrieving a file, searching the content of a file and obtaining a version of a file.

3. The computer-accessible memory medium of claim 1, wherein the API extending the class Java.io.file comprises methods for authentication at the database.

4. The computer-accessible memory medium of claim 1, wherein the at least one internal layer is configured to transform the file access request into an XQuery call.

5. The computer-accessible memory medium of claim 4, wherein the API extending the class Java.io.file includes a method for initiating the execution of an XQuery call by the internal layer.

6. The computer-accessible memory medium of claim 1, wherein the internal layer is further configured to transform the file access request into a call according to the WebDAV extensions to the HTTP protocol.

7. The computer-accessible memory medium of claim 1, wherein both the internal layer and the storage layer are provided on a database server.

8. The computer-accessible memory medium of claim 1, wherein the database is an XML database.

9. The computer-accessible memory medium of claim 1, wherein the database comprises a registry of a service oriented architecture (SOA) and wherein the files to be accessed comprise WSDL files describing the services of the SOA.

10. A method for accessing files in a physical data storage, comprising:
receiving a file access request, wherein the file access request is formatted according to an API extending the class Java.io.file;
transforming the file access request into a database call; and
a database accessing the physical storage in response to the database call.

11. The method of claim 10, wherein the API extending the class Java.io.file comprises methods for finding a file, retrieving a file, searching the content of a file and obtaining a version of a file.

12. The method of claim 10, wherein the API extending the class Java.io.file comprises methods for authentication at the database.

13. The method of claim 10, wherein said transforming comprises transforming the file access request into an XQuery call.

14. The method of claim 13, wherein the API extending the class Java.io.file includes a method for initiating the execution of an XQuery call.

15. The method of claim 10, wherein said transforming comprises transforming the file access request into a call according to the WebDAV extensions to the HTTP protocol.

16. The method of claim 10, wherein the database is an XML database.

17. The method of claim 10, wherein the database comprises a registry of a service oriented architecture (SOA) and wherein the files to be accessed comprise WSDL files describing the services of the SOA.
